(19) United States
(12) Patent Application Publication
(10) Pub. No.: US 2017/0023103 A1
(43) Pub. Date: Jan. 26, 2017

(54) FRICTION MINIMIZED BEARING STRUCTURE

(71) Applicant: Fu-Jian Liu, Taoyuan (TW)

(72) Inventor: Fu-Jian Liu, Taoyuan (TW)

(21) Appl. No.: 14/807,545

(22) Filed: Jul. 23, 2015

(51) Int. Cl. F16H 1/20; F16H 55/17

(52) U.S. Cl. CPC F16H 1/20; F16H 55/17

(57) ABSTRACT

The present invention provides a friction minimized bearing structure, which is operated in a same-speeded and contrary-directional manner, and actives an inner ring and an outer ring to rotate synchronously in contrary directions. Otherwise, rollers are mounted on a supporting gear module, the roller contacts with the outer ring of the bearing structure and rotate in contrary directions within the same rotation speed, therefore achieves a friction-minimized bearing structure. The bearing structure of present invention makes the relative velocity between the balls and the inner ring, and the outer ring is relatively down to zero or nearly zero. With such manner, an inner friction between the balls, inner ring and the outer ring may be relatively down to zero or nearly zero so as to achieve the objective of minimizing the friction.

### BACKGROUND OF THE INVENTION

1. Field of the Invention

The present invention relates to a bearing, and more particularly to a friction force minimized bearing structure.

2. Description of Related Art

A general mechanism operates by a reciprocating motion. A bearing is disposed at a turning point which functions as a combination element between rotation part such as a rotation shaft or a pivot shaft and a mounting base.

The bearing is generally mounted on an equipment as the combination element between the rotation part such as the rotation shaft or the pivot shaft and the mounting base such that the bearing can decrease the friction resistance when the rotation part is rotating.

Basically, a bearing includes an inner ring, an outer ring and multiple balls located between the inner ring and the outer ring. The outer ring is located outside the inner ring. Both of the inner ring and the outer ring include grooves. The balls are rolling in the grooves. A retainer is disposed between balls such that the balls can only roll and not slide. The balls are generally made of metal material (such as steel) and have stiffness. The balls are disposed between the inner ring and the outer ring, and two sides of each ball are contacted with the groove 104 of outer wall of the inner ring and the groove 106 of the inner wall of the outer ring.

When using, the rotation part is mounted through a hole of the inner ring. The outer ring is mounted on the mounting base 124. When the rotation part is rotating, through the rotation of the multiple balls and the lubrication of grease, the inner ring is rotated relative to the outer ring under a smaller friction.

With reference to FIG. 12 and FIG. 13, which show a basic structure of a bearing of the conventional art. The bearing includes an inner ring 103, an outer ring 105 and multiple balls 108 disposed between the inner ring 103 and the outer ring 105. The outer ring 105 is disposed outside the inner ring 103. The inner ring 103 includes a hole for receiving a rotation part 100. Wherein, at inner walls of the inner ring 103 and the outer ring 105, multiple grooves 104 and 106 are formed.

The multiple balls have stiffness and are separately disposed between the inner ring 103 and the outer ring 105 such that two sides of ball surface of each ball abut on the grooves 104, 106 at the outer wall of the inner ring 103 and the inner wall of the outer ring 105. The above describe a ball bearing, and the rolling elements are balls. If the balls are replaced by cylindrical rollers or needle rollers, the bearing becomes a cylindrical roller bearing or a needle roller bearing. The operation principles are all the same.

However, the working performance of the bearings in the conventional art depends on the status of the balls inside and the lubrication condition. Although the balls have stiffness, under friction for a long time, the balls are deformed because of abrasion. As a result, the good transmission ability of the balls is lost.

Besides, in the conventional art, when the bearing is working, for the inner ring and the outer ring, one is static and the other is rotated relatively. Therefore, the balls will receive the static friction and the dynamic friction between the outer wall of the inner ring and inner wall of the outer ring at the same time.

### SUMMARY OF THE INVENTION

In order to solve the above technology problem, a technology solution utilized by the present invention is to provide A friction minimized bearing structure, comprising: a bearing including an inner ring, an outer ring and multiple balls located between the inner ring and the outer ring; and a transmission gear module transmitting a kinetic energy generated by a rotation of the inner ring to the outer ring such that the inner ring and the outer ring are rotated in opposite rotation directions; wherein, the transmission gear module includes an inner ring gear, an outer ring gear, a first transmission gear and a second transmission gear; the outer ring gear is fixed on an outer ring roller; the outer ring roller is disposed in a middle portion among multiple supporting rollers; the outer ring roller contacts with each supporting roller; an outer edge of each supporting roller is mounted with a supporting gear; the outer ring gear is engaged with the supporting gears.

Wherein, the transmission gear module makes a rotation speed of the inner ring of the bearing and a rotation speed of the outer ring of the bearing to be the same.

Wherein, a rotation speed of the outer ring roller and a rotation speed of each supporting roller are the same or approaching to be the same, and a rotation direction of the outer ring roller and a rotation direction of each supporting roller are opposite.

Wherein, the friction minimized bearing structure is mounted on a car; the car has a car body; the car body is provided with a shaft hole and a rotation shaft which is rotatable and capable of providing a kinetic energy is disposed inside the shaft hole; an outside of a car hub of the car body is mounted with the transmission gear module; an outer ring transmission seat of the transmission gear module, the outer ring gear, a secondary bearing mounted on the outer ring gear and the inner ring gear are fixed on the car hub; the transmission gear module further includes a gear connection rod; the first transmission gear, the second transmission gear, and the gear connection rod are separated from the car hub; when the car is moving, an electromagnetic movable rod engages and fixes the gear connection rod, wherein: the inner ring gear is mounted and fixed on the rotation shaft so as to rotate in a same rotation direction relative to the rotation shaft; the outer ring transmission seat is mounted and fixed on the outer ring of the bearing so as to rotate in an opposite rotation direction of the rotation shaft; the first transmission gear engages with the inner ring gear and the second transmission gear so as to rotate in an opposite rotation direction relative to the rotation shaft, and the first transmission gear also drives the second transmission gear to rotate in the same rotation direction relative to the rotation shaft; the outer ring gear is fixed to the outer ring transmission seat in order to drive the outer ring of the bearing, and the outer ring gear is engaged with the second transmission gear in order to rotate in an opposite rotation direction relative to the second transmission gear, that is, the outer ring gear is rotated in an opposite rotation direction relative to the inner ring gear and the rotation shaft.

Wherein, the bearing includes a main bearing disposed in a shaft hole and a secondary bearing disposed adjacent to the main bearing; each inner ring of the main bearing and the secondary bearing are both tightly fixed with the rotation shaft.

Wherein, the electromagnetic movable rod is controlled by a pneumatic way.

Wherein, the electromagnetic movable rod is controlled by a spring way.

Wherein, an outer wall of the inner ring and an inner wall of the outer ring are formed with concave grooves; the multiple balls are disposed between the inner ring and the outer ring such that two sides of ball surface of each ball abut between the grooves of the outer wall of the inner ring and the inner wall of the outer ring so as to be embedded between the inner ring and the outer ring.

Wherein, the bearing is a ball bearing, a cylindrical roller bearing or a needle roller bearing.

### BRIEF DESCRIPTION OF THE DRAWINGS

FIG. 1 is a top view of a friction-minimized bearing structure according to a first embodiment of the present embodiment;

FIG. 2 is a side view of a friction-minimized bearing structure according to a first embodiment of the present embodiment;

FIG. 3 is top and side views of a mounting base of a friction-minimized bearing structure according to a first embodiment of the present embodiment;

FIG. 4 is top and side views of a supporting gear module of a friction-minimized bearing structure according to a first embodiment of the present embodiment;

FIG. 5 is top and side views of a first transmission gear module of a friction-minimized bearing structure according to a first embodiment of the present embodiment;

FIG. 6 is top and side views of a second transmission gear module of a friction-minimized bearing structure according to a first embodiment of the present embodiment;

FIG. 7 is top and side views of an outer ring gear module of a friction-minimized bearing structure according to a first embodiment of the present embodiment;

FIG. 8 is a schematic rotation diagram of a friction-minimized bearing structure according to a second embodiment of the present embodiment;

FIG. 9 is a side view of a friction-minimized bearing structure according to a second embodiment of the present embodiment;

FIG. 10 is a front view of a friction-minimized bearing structure applied to a car according to a second embodiment of the present embodiment;

FIG. 11 is a side view of a friction-minimized bearing structure applied to a car according to a second embodiment of the present embodiment;

FIG. 12 is a schematic diagram of a bearing according to the conventional art;

FIG. 13 is a side cross-sectional view of a bearing according to the conventional art;

FIG. 14 is a schematic diagram for illustrating a friction force;

FIG. 15 is a schematic diagram for illustrating velocities of an inner ring, an outer ring and a ball; and

FIG. 16 is a schematic diagram for illustrating forces applied on a main bearing and a supporting gear bearing.

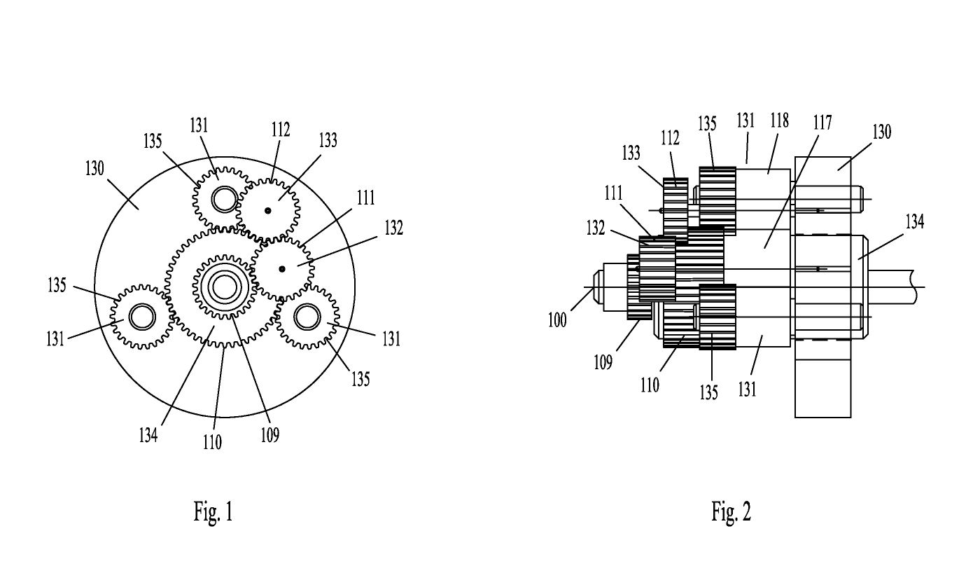

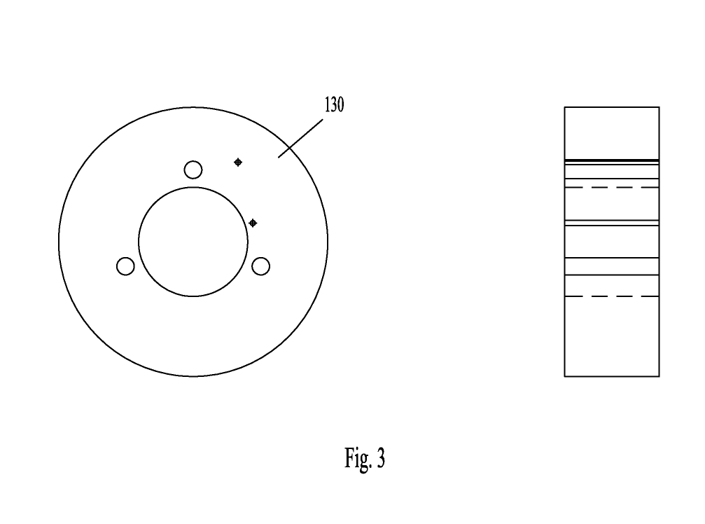

### DETAILED DESCRIPTION OF THE PREFERRED EMBODIMENT

The following will combine the drawings for further description of the present invention.

A friction force is a force that resists contacted objects to slide each other. The formula of the friction force is f=−μN.

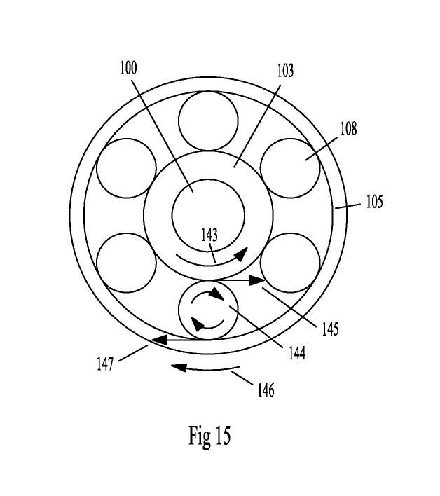

With reference to FIG. 14, two contact objects A (128) and B (129); the gravitational force of the contacted object A (128) applied on the contacted object B (129) is N (127). A friction coefficient between the two contacted objects A (128) and B (129) is μ. When the friction force is generated continuously within a distance d, a work (W) done is:

W=−μN·d;

a power (P) is:

P=−μN·d/t=−μN·v;

In the above formula, v is a relative velocity between the two contacted objects A (128) and B (129).

When the relative velocity v=0, the power P is also equal to 0, that is, the friction force does not act. In other words, when the relative velocity between two contacted objects A (128) and B (129) is 0, even the two contacted objects A (128) and B (129) are still moving, the contacted object A (128) and the contacted object B (129) are moving in a same velocity. A friction force between the contacted objects A (128) and B (129) will not be generated.

The friction-minimized bearing structure of the present invention can minimize a friction force through a simple principle and a simple structure so as to provide a high suitability and is convenient for a practical application. The present invention can be easily and conveniently applied to existing equipment through an additional installation or modification.

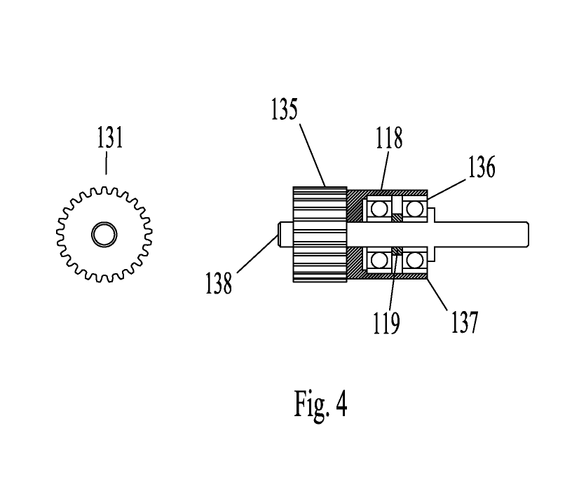

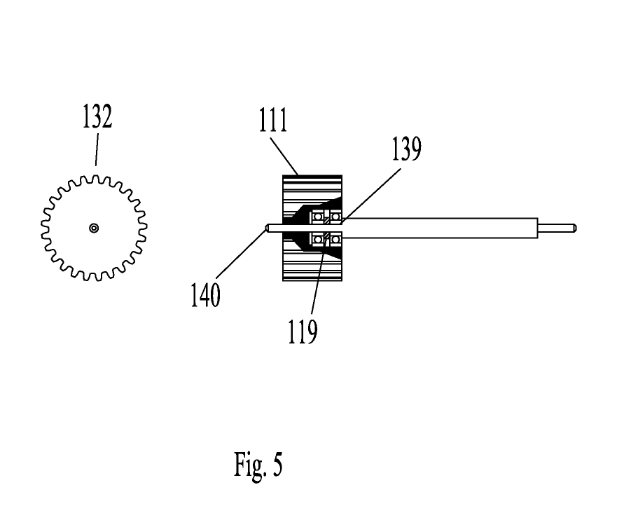

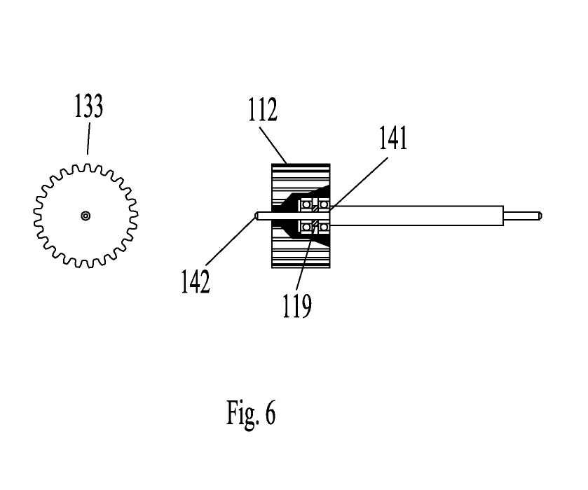

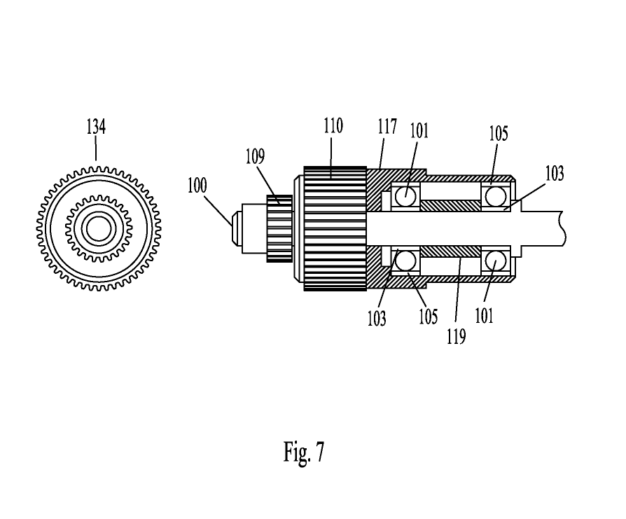

With reference to a supporting gear module 131 in FIG. 4 and an outer ring gear module 134 in FIG. 7, the present invention adds a supporting gear 135 on a roller 118 of the supporting gear module 131, a relationship of the number of teeth of the supporting gear 135, a diameter of the roller 118, the number of teeth of the outer ring gear 110, and a diameter of the roller 117 is as following:

πD1/(the number of teeth of the outer ring gear)=πD2/(the number of teeth of the supporting gear), wherein,

D1: the diameter of the outer ring gear roller 117;

D2: the diameter of the supporting gear roller 118;

Therefore, a moved curve distance of the outer ring gear roller 117 corresponds to move a tooth of the outer ring gear 110 is equal to a moved curve distance of the supporting gear roller 118. As a result, a relative velocity between the outer ring gear roller 117 and the supporting gear roller 118 is zero or approaching to zero such that a friction force between the outer ring gear roller 117 and the supporting gear roller 118 is minimized.

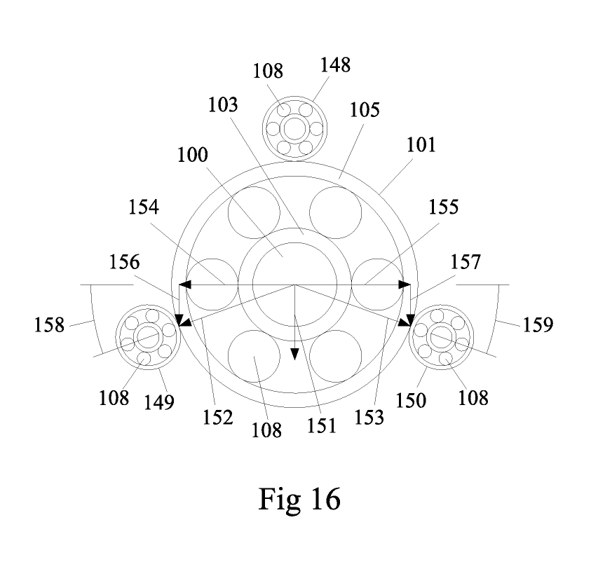

With reference to FIG. 16, FIG. 16 is a schematic diagram for illustrating forces applied on a main bearing and a supporting gear bearing. The diagram illustrates a force distribution of the main bearing and multiple supporting gear bearings for supporting the main bearing. In the diagram, various accessories are omitted and the force distribution of the main bearing and the supporting gear bearings is directly shown.

A rotation shaft 100 passes through the middle portion of the main bearing 101. In a general application, an outer wall of an outer ring 105 is fixed. A vertical gravitational load 151 of the rotation shaft 100 cause a friction force to be generated among the main bearing 101, the inner ring 103, the outer ring 105 and the balls 108. The magnitudes of the friction forces are different according to locations of the balls. The present invention disposes the outer ring gear module 134 of the main bearing 101 among multiple supporting gear modules 131 which are used for supporting. Outer ring roller is disposed among multiple supporting rollers and the outer ring roller is contacted with every supporting rollers. An outer edge of each supporting roller is mounted with a supporting gear. The outer ring gear is engaged with every supporting gear. Through a transmission gear module which includes an inner ring gear, a first transmission gear, a second transmission gear, an outer ring gear and relative accessories, the outer ring 105 and the inner ring 103 of the main bearing 101 are rotated in a same speed and opposite directions so that a relative velocity between a ball 108 and the outer ring 105 and a relative velocity between a ball 108 and the inner ring 103 are zero or approaching to zero. Accordingly, the friction force inside the main bearing 101 is minimized.

With reference to FIG. 16, a distribution position of the multiple supporting bearings can be different according to the practical application. For illustration, a vertical supporting gear bearing 148, a left side supporting bearing 149 and a right side supporting gear bearing 150 are shown. The vertical supporting gear bearing 148 is located right above the vertical gravitational load 151 of the rotation shaft 100. Because the vertical supporting gear bearing 148 is not affected by the vertical gravitational load 151, the internal friction force is very small. The main friction force is generated from the left side supporting gear bearing 149 and the right side supporting gear bearing 150.

Action forces are respectively a left side supporting gear bearing action force 152 and a right side supporting gear bearing action force 153. The left side supporting gear bearing action force 152 is along a center line of the rotation shaft 100 and a left side supporting gear shaft 149 and the action force 152 is denoted as F8. The right side supporting gear bearing action force 153 is along a center line of the rotation shaft 100 and a right side supporting gear shaft 150 and the action force 153 is denoted as F9. The left side supporting gear bearing action force 152 is composed of a left side horizontal component force 154 and a left side vertical component force 156, and an included angle 158 between the left side horizontal component force 154 and the left side vertical component force 156 is θ1. The right side supporting gear bearing action force 153 is composed of a right side horizontal component force 155 and a right side vertical component force 157, and an included angle 159 between the right side horizontal component force 155 and the right side vertical component force 157 is θ2.

Assuming that:

The left side vertical component force 156 is F1; the included angle is θ1; F1=F8·Sin θ1;

The right side vertical component force 157 is F2; the included angle is θ2; F2=F9·Sin θ2;

The vertical gravitational load 151 of the rotation shaft 100 is F3;

The left side horizontal component force 154 is F4; F4=F8·Cos 1;

The right side horizontal component force 155 is F5; F5=F9·Cos θ2;

When θ1 and θ2 are appropriately selected, a sum of the left side vertical component force 156 and the right side vertical component force 157 is equal to the vertical gravitational load 151 of the rotation shaft 100.

That is, F1+F2=F3

At this time, θ1+θ2=θ3;

A sum of horizontal component forces is F6;

F4+F5=F6;

When θ1+θ2<θ3, a sum of the left side vertical component force 156 and the right side vertical component force 157 is smaller than F3.

That is, F1+F2<F3; and

F4+F5>F6;

When gradually moving to reduce the left side included angle 158 and the right side included angle 159, and maintaining the system ability at the same time, that is:

θ1+θ2<<θ3;

Then, F1+F2<<3;

And, F4+F5>>F6;

However, directions of the left horizontal component force 154 and the right horizontal component force 155 are opposite so that the two forces are canceled with each other. When the included angles θ1 and θ2 are equal, a resultant force of the two horizontal component forces is zero. Accordingly, appropriately selecting the included angles θ1 and θ2 can reduce external forces act on the supporting bearing, the vertical gravitational load 151 (F3) is reduced so as to achieve the purpose of minimizing the system friction force.

Assuming that:

When θ1 and θ2 are moving upward such that each of the included angles is 15°, that is, θ1=θ2=15°;

F1=F2=½F3·Sin 15°;

F1+F2=F3·Sin 15°=0.259 F3;

For the left side horizontal component force and the right side horizontal component force,

F4=−F5=½F3·Cos 15°;

Accordingly, the vertical gravitational load sustained by the system is also reduced to 25.9% of the original value. The friction force is proportional to the vertical gravitational load of the system so that the friction force is also reduced to 25.9% of the original value and the friction energy inside the bearing is also reduced about 74%.

The present invention is not limited to the above angles. The present invention can be applied to various angles. The present invention is also not limited to θ1=θ2, and also can be applied to various angles.

The above is a first embodiment of a friction minimized bearing of the present invention.

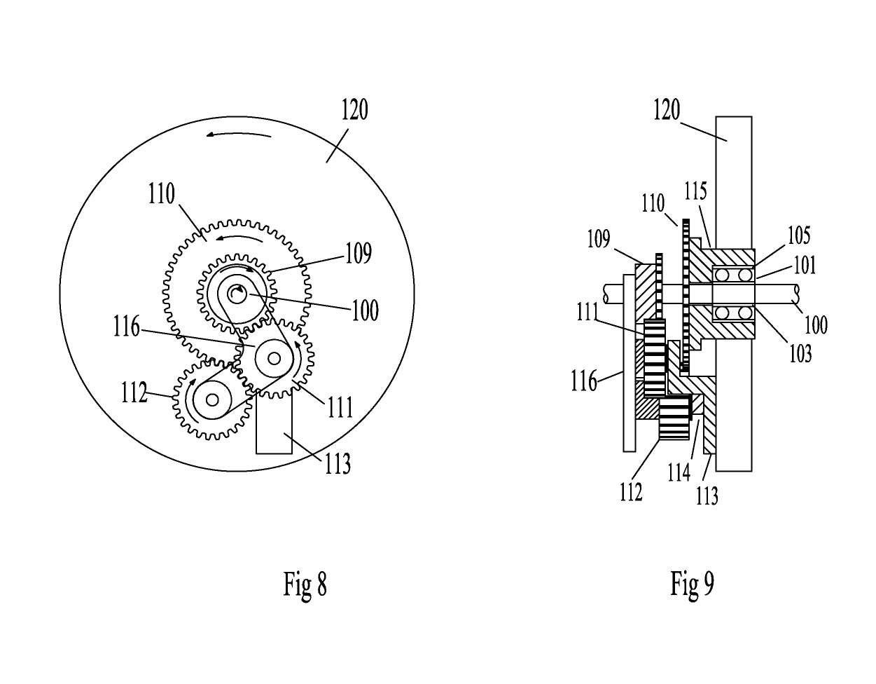

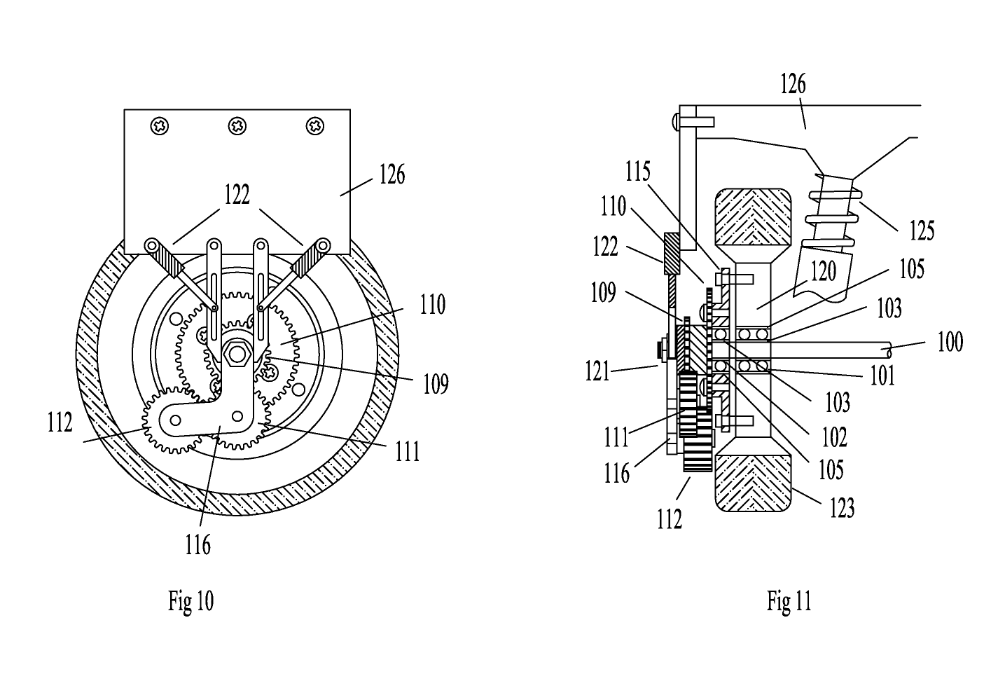

With reference to FIG. 8, FIG. 9, FIG. 10 and FIG. 11, which illustrates a second embodiment of a friction minimized bearing structure of the present invention. The friction minimized bearing structure of the present invention utilizes a car for the mounting base, and includes:

Bearings, which includes a main bearing 101 disposed in a shaft hole and a secondary bearing 102 disposed adjacent to the main bearing 101. Each of the main bearing 101 and the secondary bearing 102 includes an inner ring 103, an outer ring 105 and multiple balls 108 disposed between the inner ring 103 and the outer ring 105 for transmission. The inner rings 103 of the main bearing 101 and the secondary ring 102 are tightly fixed with the rotation shaft 100. An outer wall of the inner ring 103 and the inner wall of the outer ring 105 are formed with concave grooves 104, 106.

Every ball 108 has a stiffness, and the multiple balls 108 are separately disposed between the inner ring 103 and the outer ring 105. Two sides of each ball surface abut on the grooves 104, 106 of the outer wall of the inner ring 103 and inner wall of the outer ring 105 so that the balls 108 are fixed between the inner ring 103 and the outer ring 105.

Transmission gear module includes an inner ring gear 109, an outer ring transmission seat 115, a first transmission gear 111, a second transmission gear 112 and an outer ring gear 110. Wherein, the inner ring gear 109 is mounted and fixed at the rotation shaft 100 so that the inner ring gear 109 has the same rotation speed as the rotation shaft 100.

The outer ring transmission seat 115 is disposed and fixed on the outer ring 105 of the main bearing 101. The first transmission gear 111 and the second transmission gear 112 are pivotally mounted on a gear connection rod 116 so that the first transmission gear 111, the second transmission gear 112 and the gear connection rod 116 are connected with each other. Wherein, the first transmission gear 111 and the second transmission gear 112 can rotate relatively. A radius and the number of teeth of each first transmission gear 111, the second transmission gear 112 and the inner ring gear 109 are the same. Wherein, the first transmission gear 111 is engaged with the inner ring gear 109 and the second transmission gear 112. Besides, when the inner ring 103 is rotated, the inner ring gear 109 drives the second transmission gear 112 such that the second transmission gear 112 and the rotation shaft 100 are both rotated in a same rotation direction.

The outer ring gear 110 is fixed on the outer ring transmission seat 115 so as to drive the outer ring 105 of the secondary bearing 102. Besides, the outer ring gear 110 is engaged with the second transmission gear 112 such that the outer ring gear 110 is rotated in an opposite rotation direction relative to the second transmission gear 112. That is, the outer ring gear 110 is rotated in the same rotation speed and an opposite rotation direction relative to the inner ring gear 109 and the rotation shaft 100.

Furthermore, a ratio of the number of teeth of the inner ring gear 109 to the outer ring gear 110 is equal to a ratio of the radius of the inner ring 103 to the radius of the outer ring 105, and is also equal to a ratio of the rotation speed of the outer ring gear 110 to the rotation speed of inner ring gear 109.

When the rotation shaft 100 is rotated, the secondary bearing 102 is rotated synchronously, the inner ring 103 and the outer ring 105 of the secondary bearing 102 are rotated in the opposite rotation directions. In this condition, with reference to FIG. 15, at a contact point of a side of the ball 108 of the secondary bearing 102 and the inner ring 103, the ball 108 and the inner ring 103 are moved in a tangential velocity having the same direction so that a relative velocity of the ball 108 and the inner ring 103 is a subtraction of the velocity of the ball 108 and the velocity of the inner ring 103. If the velocities of the ball 108 and the inner ring 103 are equal or almost equal, the relative velocity of the ball 108 and the inner ring 103 is zero or approaching to zero.

Similarly, at a contact point of another side of the ball 108 and the outer ring 105, the another side of the ball 108 and the outer ring 105 are moved in a tangential velocity having the same direction so that a relative velocity of the another side of the ball 108 and the outer ring 105 is a subtraction of the velocity of the another side of the ball 108 and the velocity of the outer ring 105. If the velocities of the another side of the ball 108 and the outer ring 105 are equal or almost equal, the relative velocity of the another side of the ball 108 and the outer ring 105 is zero or approaching to zero. In the above situation, because a relative velocity of each ball 108 inside the secondary bearing 102 and the inner ring 103, and a relative velocity of each ball 108 inside the secondary bearing 102 and the outer ring 105 are both zero or approaching to zero, so that a friction force of each ball 108 inside the secondary bearing 102 and the inner ring 103 and a friction force of each ball 108 inside the secondary bearing 102 and the outer ring 105 are both zero or approaching to zero.

Accordingly, when the car is operating, the main bearing 101 can generate the same effect so that the friction force generated by the car load can be minimized.

With reference to FIG. 11, the car includes a suspension system 125, the suspension system 125 is connected with a car body support 126. A side of the suspension system 125 is provided with a car hub 120 and a tire 123 disposed on the car hub 120. Inside the car hub 120, the main bearing 101 is provided. The rotation shaft 100 passes through the main bearing 101. The rotation shaft 100 is connected with an engine crankshaft component, which can rotate and provide a kinetic energy.

An outside of the car hub of the car body is mounted with a transmission gear module. The outer ring transmission seat of the transmission gear module and the outer ring gear are fixed on the car hub. The remaining parts of the transmission gear module includes a secondary bearing and an inner ring gear mounted on the secondary bearing, an outer ring transmission seat, a first transmission gear, a second transmission gear, an outer ring gear, a gear connection rod and so on, which are separated from the car hub. Wherein, the first transmission gear, the second transmission gear are fixed with the gear connection rod. When the car is moving, the electromagnetic movable rod mounted on the car body engages and fixes the gear connection rod. Wherein:

The inner ring gear is mounted and fixed on the rotation shaft, and the inner ring gear is rotated in the same rotation direction as the rotation shaft. The outer ring transmission seat is mounted and fixed on the outer ring of the bearing so as to rotate in an opposite rotation direction relative to the car body shaft. The first transmission gear engages with the inner ring gear and the second transmission gear so as to rotate in an opposite rotation direction relative to the rotation shaft. At the same time, the first transmission gear drives the second transmission gear to rotate in the same rotation direction as the rotation shaft. The outer ring gear is fixed on the outer ring transmission seat, and the outer ring gear engages with the second transmission gear so that the outer ring gear is rotated in an opposite rotation direction relative to the second transmission gear. That is, the inner ring gear and the rotation shaft are rotated in opposite rotation directions.

When braking, the electromagnetic movable rod is released and separated from the gear connection rod. The second transmission gear does not drive the outer ring gear anymore. The outer ring of the second bearing is idling. The outer ring of the main bearing does not affect by the transmission gear module.

The electromagnetic movable rod and the accessory utilize the electromagnetic property to control the activity rod and the accessory. A pneumatic driving way can replace the electromagnetic way to control the activity rod and the accessory. When braking, the pneumatic driving rod is released and separated from the gear connection rod. When the car is moving, the pneumatic activity rod engages and fixes the gear connection rod.

Through above structure and transmission way of the transmission gear module, the outer ring of the bearing is driven through the outer ring transmission seat by the outer ring gear such that the outer ring of the bearing is rotated in an opposite rotation direction relative to the inner ring of the bearing.

Accordingly, the friction force inside the secondary bearing 102 and the main bearing 101 is minimized. The above is a second embodiment of the friction minimized bearing structure, which can be applied on the wheel of the car so as to minimize the friction force of the bearings inside the wheel.

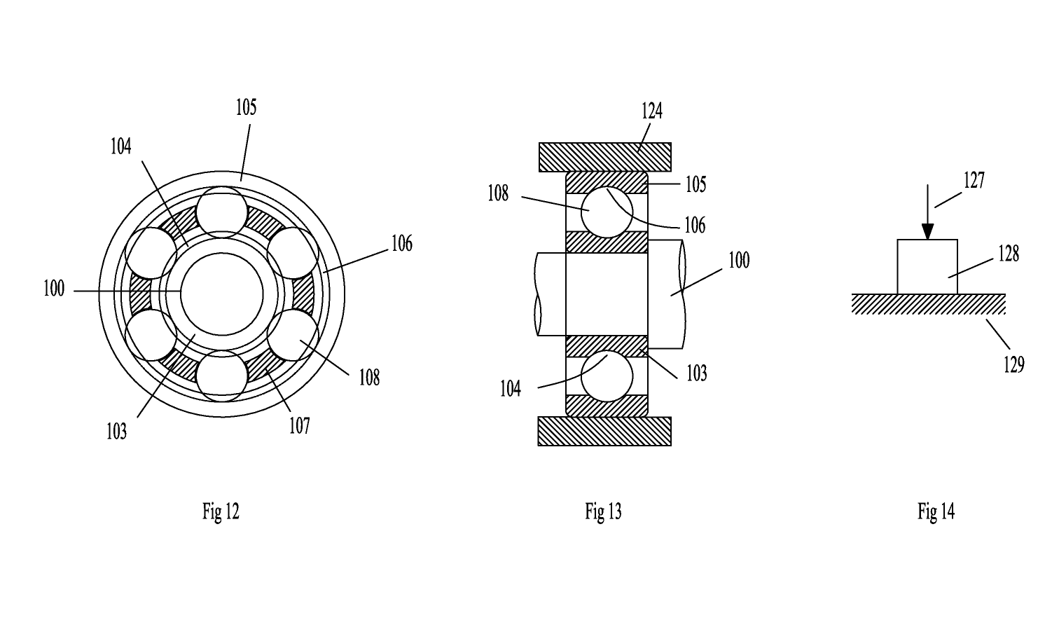

With reference to FIG. 11 and FIG. 12, the present invention further includes an electromagnetic movable rod 122. The electromagnetic movable rod 122 can lock the gear connection rod 116 when the car is moving so that every gear is rotated normally. When the car is braking, the electromagnetic movable rod 122 released from the gear connection rod 116 such that the second transmission gear does not drive the outer ring gear anymore. The purpose is to eliminate the friction force of the bearing inside the car hub of the car when driving, and when braking, the internal stress of the gear is decreased.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A friction minimized bearing structure, comprising:
a bearing including an inner ring, an outer ring and multiple balls located between the inner ring and the outer ring; and
a transmission gear module transmitting a kinetic energy generated by a rotation of the inner ring to the outer ring such that the inner ring and the outer ring are rotated in opposite rotation directions;
wherein, the transmission gear module includes an inner ring gear, an outer ring gear, a first transmission gear and a second transmission gear; the outer ring gear is fixed on an outer ring roller; the outer ring roller is disposed in a middle portion among multiple supporting rollers; the outer ring roller contacts with each supporting roller; an outer edge of each supporting roller is mounted with a supporting gear; the outer ring gear is engaged with the supporting gears.

2. The friction minimized bearing structure according to claim 1, the transmission gear module makes a rotation speed of the inner ring of the bearing and a rotation speed of the outer ring of the bearing to be the same.

3. The friction minimized bearing structure according to claim 1, a rotation speed of the outer ring roller and a rotation speed of each supporting roller are the same or approaching to be the same, and a rotation direction of the outer ring roller and a rotation direction of each supporting roller are opposite.

4. The friction minimized bearing structure according to claim 1, wherein, the friction minimized bearing structure is mounted on a car; the car has a car body; the car body is provided with a shaft hole and a rotation shaft which is rotatable and capable of providing a kinetic energy is disposed inside the shaft hole; an outside of a car hub of the car body is mounted with the transmission gear module; an outer ring transmission seat of the transmission gear module, the outer ring gear, a secondary bearing mounted on the outer ring gear and the inner ring gear are fixed on the car hub; the transmission gear module further includes a gear connection rod; the first transmission gear, the second transmission gear, and the gear connection rod are separated from the car hub;
when the car is moving, an electromagnetic movable rod engages and fixes the gear connection rod, wherein:
the inner ring gear is mounted and fixed on the rotation shaft so as to rotate in a same rotation direction relative to the rotation shaft;
the outer ring transmission seat is mounted and fixed on the outer ring of the bearing so as to rotate in an opposite rotation direction of the rotation shaft;
the first transmission gear engages with the inner ring gear and the second transmission gear so as to rotate in an opposite rotation direction relative to the rotation shaft, and the first transmission gear also drives the second transmission gear to rotate in the same rotation direction relative to the rotation shaft;
the outer ring gear is fixed to the outer ring transmission seat in order to drive the outer ring of the bearing, and the outer ring gear is engaged with the second transmission gear in order to rotate in an opposite rotation direction relative to the second transmission gear, that is, the outer ring gear is rotated in an opposite rotation direction relative to the inner ring gear and the rotation shaft.

5. The friction minimized bearing structure according to claim 2, wherein, the bearing includes a main bearing disposed in a shaft hole and a secondary bearing disposed adjacent to the main bearing; each inner ring of the main bearing and the secondary bearing are both tightly fixed with the rotation shaft.

6. The friction minimized bearing structure according to claim 4, wherein, the electromagnetic movable rod is controlled by a pneumatic way.

7. The friction minimized bearing structure according to claim 4, wherein, the electromagnetic movable rod is controlled by a spring way.

8. The friction minimized bearing structure according to claim 1, wherein, an outer wall of the inner ring and an inner wall of the outer ring are formed with concave grooves; the multiple balls are disposed between the inner ring and the outer ring such that two sides of ball surface of each ball abut between the grooves of the outer wall of the inner ring and the inner wall of the outer ring so as to be embedded between the inner ring and the outer ring.

9. The friction minimized bearing structure according to claim 2, wherein, an outer wall of the inner ring and an inner wall of the outer ring are formed with concave grooves; the multiple balls are disposed between the inner ring and the outer ring such that two sides of ball surface of each ball abut between the grooves of the outer wall of the inner ring and the inner wall of the outer ring so as to be embedded between the inner ring and the outer ring.

10. The friction minimized bearing structure according to claim 1, wherein, the bearing is a ball bearing, a cylindrical roller bearing or a needle roller bearing.

11. The friction minimized bearing structure according to claim 2, wherein, the bearing is a ball bearing, a cylindrical roller bearing or a needle roller bearing.
